(19) United States
(12) Patent Application Publication
(10) Pub. No.: US 2024/0087041 A1
(43) Pub. Date: Mar. 14, 2024

(54) INFORMATION PROVISION DEVICE, INFORMATION PROVISION METHOD, AND INSURANCE INFORMATION SYSTEM

(71) Applicant: HONDA MOTOR CO., LTD., Tokyo (JP)

(72) Inventor: Yuji Takeuchi, Tokyo (JP)

(21) Appl. No.: 18/461,584

(22) Filed: Sep. 6, 2023

(30) Foreign Application Priority Data
Sep. 12, 2022 (JP) 2022-144850

(51) Int. Cl. G06Q 40/08; G08G 1/017

(52) U.S. Cl. CPC G06Q 40/08; G08G 1/017

(57) ABSTRACT

An information provision device includes a processor that collects traveling data of object vehicles, provides traveling data, and collates object vehicle information for each object vehicle with designation information from an external device and identify an object vehicle from which the traveling data should be provided. The processor collates an object vehicle registration number being a vehicle registration number of the object vehicle included in the object vehicle information with a designated vehicle registration number being a vehicle registration number indicated by the designation information, and identifies an object vehicle whose object vehicle registration number coincides with the designated vehicle registration number. The vehicle registration number is a unique code string for identifying each vehicle while associating the vehicle with an owner of the vehicle. The processor transmits, to the external device, traveling data about the object vehicle identified.

### INCORPORATION BY REFERENCE

The present application claims priority under 35 U.S.C.§ 119 to Japanese Patent Application No. 2022-144850 filed on Sep. 12, 2022. The content of the application is incorporated herein by reference in its entirety.

### BACKGROUND OF THE INVENTION

### Field of the Invention

The present invention relates to an information provision device, an information provision method, and an insurance information system.

### Description of the Related Art

Japanese Patent Laid-Open No. 2012-3297 discloses an insurance information processing method for meter-rate charging automobile insurance in which an application for use and payment of an insurance premium are performed, at each use, without limiting an object vehicle in advance. This insurance information processing method includes receiving, from an applicant's terminal, use application data including a registration number of a vehicle to be insured this time, and determining whether there is a contract including the registration number in contract data about general automobile insurance in which an object vehicle is specified. The method further includes, when it is determined that there is a contract for general automobile insurance including the registration number and the contract is applied to this applicant, transmitting, to the applicant's terminal, transmission data for causing the applicant to confirm about using meter-rate charging automobile insurance in addition to the contract of the general automobile insurance.

Apart from adjustment of the above-described duplicate application of two insurance contracts for the same vehicle, there is a need for an insurance company that handles vehicle insurance to obtain information on how the object vehicle being an insurance object is operated in driving such as dangerous driving. Therefore, for example, it is conceivable that an information provision device communicably connected to an insurance company's server collects traveling data from the object vehicle to which the vehicle insurance is applied, and provides the insurance company's server with the collected traveling data in response to reception of a provision request from the server.

In this case, it is necessary for the information provision device to confirm the owner identity between the vehicle designated by the provision request from the insurance company and a vehicle whose traveling data is to be transmitted, so that traveling data of a vehicle whose owner is different from that of the vehicle whose traveling data is requested by the insurance company is not transmitted to the insurance company's server.

However, for example, if vehicle information in the information provision device and vehicle information in the insurance company's server are individually corrected at mutually different times, a period in which owner information about the same object vehicle differs between the information provision device and the insurance company's server will be caused. In this case, it will be difficult for the information provision device to correctly determine the owner identity between the vehicle being a collection source of traveling data to be transmitted to the insurance company's server and the vehicle designated by the provision request received from the insurance company's server. As a result, the traveling data may not be appropriately transmitted to the insurance company's server.

It is an object of the present invention to provide an information provision device that transmits, in response to a provision request from an external device, traveling data collected from a vehicle to the external device, in which the vehicle designated by the provision request can be identified, without error, from the viewpoint of the same owner and the traveling data of the designated vehicle can be appropriately transmitted to the external device.

### SUMMARY OF THE INVENTION

According to an aspect of the present invention, an information provision device includes: a collection unit configured to collect traveling data of a plurality of object vehicles; a provision unit configured to provide, in response to a provision request from an external device, the traveling data to the external device; and a collation unit configured to collate object vehicle information for each object vehicle, including information about the object vehicle, with designation information included in the provision request, respectively, and identify an object vehicle from which the traveling data should be provided to the external device. The collation unit collates an object vehicle registration number being a vehicle registration number of the object vehicle, included in the object vehicle information, with a designated vehicle registration number being a vehicle registration number of a vehicle designated by the designation information, included in the designation information, and identifies an object vehicle whose object vehicle registration number coincides with the designated vehicle registration number, as the object vehicle from which the traveling data should be provided to the external device. The vehicle registration number is a unique code string for identifying each vehicle while associating the vehicle with an owner of the vehicle. The provision unit transmits, to the external device, the traveling data about the object vehicle identified by the collation unit.

According to another aspect of the present invention, the vehicle registration number is a code string displayed on the number plate of the vehicle in compliance with regulations.

According to another aspect of the present invention, the collation unit further collates an object vehicle identification number being a vehicle identification number of the object vehicle, included in the object vehicle information, with a designated vehicle identification number being a vehicle identification number of a vehicle designated by the designation information, included in the designation information, and identifies the object vehicle whose object vehicle registration number coincides with the designated vehicle registration number and whose object vehicle identification number coincides with the designated vehicle identification number, as the object vehicle from which the traveling data should be provided to the According to another aspect of the present invention, the collation unit identifies, as the object vehicle from which the traveling data should be provided to the external device, an object vehicle as long as the object vehicle registration number coincides with the designated vehicle registration number and the object vehicle identification number coincides with the designated vehicle identification number, even when information other than the designated vehicle registration number and the designated vehicle identification number, included in the designation information, does not coincide with information other than the object vehicle registration number and the object vehicle identification number, included in the object vehicle information.

According to another aspect of the present invention, a position acquisition unit configured to acquire position information being information on the present position of the object vehicle is provided. The position acquisition unit identifies, from among positions where the object vehicle has been parked, a position where the number of times of parking or total parking duration, per predetermined number of days, is equal to or greater than a predetermined number of times or equal to or greater than a predetermined amount of time, respectively, as a steady parking position of the object vehicle. The provision unit does not transmit, when there is a change in the steady parking position of the object vehicle, the traveling data from the object vehicle to the external device.

According to another aspect of the present invention, an information provision method that a computer of an information provision device executes is provided. The information provision method includes: a collection step collecting traveling data of a plurality of object vehicles; a provision step of providing, in response to a provision request from an external device, the traveling data to the external device; and a collation step of collating object vehicle information for each object vehicle, including information about the object vehicle, with designation information included in the provision request, respectively, and identifying an object vehicle from which the traveling data should be provided to the external device. The collation step includes collating an object vehicle registration number being a vehicle registration number of the object vehicle, included in the object vehicle information, with a designated vehicle registration number being a vehicle registration number of a vehicle designated by the designation information, included in the designation information, and identifying an object vehicle whose object vehicle registration number coincides with the designated vehicle registration number, as the object vehicle from which the traveling data should be provided to the external device. The vehicle registration number is a unique code string for identifying each vehicle while associating the vehicle with an owner of the vehicle. The provision step includes transmitting, to the external device, the traveling data about the object vehicle identified in the collation step.

According to the present invention, in the information provision device that transmits, in response to a provision request from an external device, traveling data collected from vehicles to this external device, it is possible to identify the vehicle designated by the provision request without error, from the viewpoint of the same owner and appropriately transmit the traveling data of the designated vehicle to the external device.

### BRIEF DESCRIPTION OF THE DRAWINGS

FIG. 1 is a configuration diagram illustrating an insurance information processing system including an information provision device according to an embodiment of the present invention;

FIG. 2 is a configuration diagram illustrating the information provision device;

FIG. 3 is a configuration diagram illustrating an insurance company server that is an external device; and

FIG. 4 is a flow diagram illustrating an exemplary procedure of processing in an information provision method that the information provision device executes.

### DETAILED DESCRIPTION OF THE PREFERRED EMBODIMENT

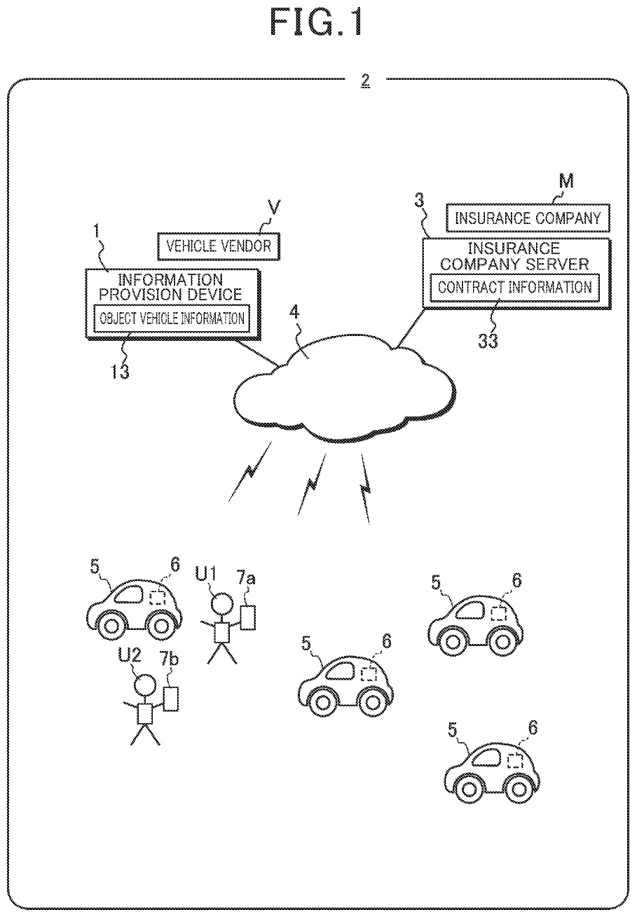

Hereinafter, embodiments of the present invention will be described with reference to attached drawings. FIG. 1 is a configuration diagram illustrating an insurance information system using an information provision device according to an embodiment of the present invention. An information provision device 1 configures an insurance information system 2, together with an insurance company server 3, which is an external device. The information provision device 1 and the insurance company server 3 are communicably connected to each other via a communication network 4 such as the Internet.

The information provision device 1 collects traveling data from each of object vehicles 5, and provides the insurance company server 3 with the collected traveling data. Collection and provision of the traveling data can be carried out, for example, through communications via the communication network 4.

The information provision device 1 can be, for example, a server or a part thereof, which is operated by a vehicle vendor V. The information provision device 1 stores, in advance, object vehicle information 13 including information on respective object vehicles 5, for each of the object vehicles 5 whose traveling data is to be collected. For example, the object vehicle information 13 may include identification information of each object vehicle 5, access information for communication, name/address/driver's license information of the owner of each object vehicle 5, identification information at the vehicle vendor V, and also include name/address information of user U2, who is a family member (family user) of owner U1.

Each of the object vehicles 5 collects the traveling data using an on-vehicle device 6 and transmits the collected data to the information provision device 1. The traveling data may include various data about distance traveled, driving speed, hard acceleration, hard braking, and hard steering.

The insurance company server 3 is a server operated by an insurance company M that handles vehicle insurance, and stores contract information 33 on insurance contract for each object vehicle 5 being an insurance object. The contract information 33 may include identification information of the object vehicle 5, owner information, contractor name/address, identification information at the insurance company M, identification information at the vehicle vendor V.

The user U1 being the owner of the object vehicle 5 and/or the user U2 being the family user can change or renew the object vehicle information 13 and the contract information 33 about the object vehicle 5, by requesting the vehicle vendor V or the insurance company M, or by accessing the information provision device 1 and the insurance company server 3 using terminal devices 7a and 7b owned by themselves. The terminal devices 7a and 7b may be, for example, portable terminals such as smartphones. The above-described change or renewal may be, for example, changing address of the user U1 or U2, changing the owner of the object vehicle 5, or changing the insurance contractor.

In FIG. 1, the multiple object vehicles 5 are vehicles owned by the same person or different persons, respectively. For each object vehicle 5, the object vehicle information 13 and the contract information 33 similar to those described above are stored in the information provision device 1 and the insurance company server 3.

In response to reception of a provision request from the insurance company server 3, the information provision device 1 provides the insurance company server 3 with corresponding traveling data of the object vehicle 5. The provision request includes designation information. The information provision device 1 identifies the object vehicle 5 whose traveling data should be provided to the insurance company server 3 (that is, determines which traveling data of the object vehicle 5 should be provided to the insurance company server 3), by collating each piece of the object vehicle information 13 with the designation information. For example, the insurance company server 3 can generate the above-described designation information based on the contract information 33.

In the present embodiment, especially, the information provision device 1 collates an object vehicle registration number being a vehicle registration number of the object vehicle 5, included in the object vehicle information 13, with a designated vehicle registration number being a vehicle registration number of a vehicle designated by the designation information, included in the designation information, and identifies an object vehicle 5 whose object vehicle registration number coincides with the designated vehicle registration number, as the object vehicle 5 whose traveling data should be provided to the insurance company server 3. Here, the above-described vehicle registration number is a unique code string for identifying each vehicle while associating the vehicle with an owner of the vehicle. Specifically, the vehicle registration number may be a code string (which may include numbers, symbols, and/or characters) displayed on a number plate (or license plate, registration plate, or equivalent thereof) of the vehicle in compliance with regulations.

As a result, in the information provision device 1, individually changing the object vehicle information 13 stored by the information provision device 1 and/or the contract information 33 stored by the insurance company server 3, at mutually different times, may cause a period in which the owner information included in the object vehicle information 13 and the owner information included in the contract information 33 are different from each other, with respect to the same object vehicle 5. Even in such a case, collating the vehicle registration numbers with each other makes it possible to identify the object vehicle 5 designated by the designation information included in the provision request from the insurance company server 3, without error, from the viewpoint of the same owner, and appropriately provide the insurance company server 3 with the traveling data of the designated object vehicle 5.

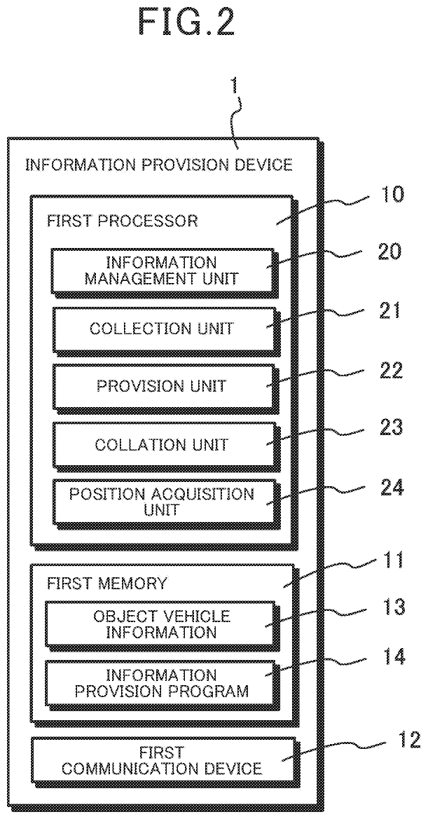

FIG. 2 is a diagram illustrating an exemplary configuration of the information provision device 1. The information provision device 1 includes a first processor 10, a first memory 11, and a first communication device 12. The first communication device 12 is a transmitter/receiver for enabling the information provision device 1 to communicate with the object vehicles 5 and the insurance company server 3 via the communication network 4. The first memory 11 is configured by a volatile and/or nonvolatile semiconductor memory and/or a hard disk device, for example.

The first memory 11 stores, in advance, the object vehicle information 13 for each object vehicle 5. Each piece of the object vehicle information 13 includes identification information of the corresponding object vehicle 5. As described below, in the present embodiment, the identification information of the object vehicle 5 is vehicle registration number consisting of a unique code string for identifying each vehicle while associating the vehicle with an owner of the vehicle. Specifically, the identification information of the object vehicle 5 is a code string displayed on the number plate of the vehicle in compliance with regulations, for example.

The object vehicle information 13 may include, as information other than the object vehicle registration number, access information for communication with the object vehicle 5, name/address/driver's license information of the owner of the object vehicle 5, identification information at the vehicle vendor V, and also include name/address information of the user U2 being a family user and identification information at the vehicle vendor V.

The first processor 10 is, for example, a computer including a processor such as a central processing unit (CPU). The configuration of the first processor 10 may include a read only memory (ROM) for programs installed and a random access memory (RAM) for temporary storage of various data. In addition, the first processor 10 includes, as functional elements or functional units, an information management unit 20, a collection unit 21, a provision unit 22, a collation unit 23, and a position acquisition unit 24.

These functional elements provided in the first processor 10 can be realized, for example, when the first processor 10 being the computer executes an information provision program 14 stored in the first memory 11. The information provision program 14 may be stored in an arbitrary computer-readable storage medium. Alternatively, the whole or part of the above-described functional elements in the first processor 10 can be configured by hardware including one or more electronic circuit components, respectively.

The information management unit 20, when receiving a correction request for instructing correction of the object vehicle information 13 from the terminal devices 7a and 7b of the users U1 and U2, corrects contents of the object vehicle information 13 about the corresponding the object vehicle 5 according to the contents of the correction request. Alternatively, an operator of the vehicle vendor V operating the information provision device 1 may input a correction request for instructing correction of the object vehicle information 13, in response to a request from the user U1 or U2, to the information provision device 1. The correction request may include, for example, vehicle identification number (VIN) of the vehicle to be subjected to the information correction. The information management unit 20 performs searching based on the vehicle identification number included in the correction request and can identify the object vehicle information 13 to be corrected. Here, the vehicle identification number (VIN) is a unique code consisting of alphanumeric characters defined by the International Organization for Standardization (ISO) 3833 and stamped on each vehicle body for identifying this vehicle body. The vehicle identification number (VIN) may also be referred to as vehicle body number.

The collection unit 21 collects traveling data of the plurality of object vehicles 5. For example, the collection unit 21 receives and collects the traveling data from the object vehicles 5, with the aid of the first communication device 12, via the communication network 4. As described above, the traveling data may include the data about distance traveled and hard acceleration.

In response to the provision request received from the insurance company server 3 being an external device, the provision unit 22 provides the insurance company server 3 with the traveling data of the object vehicle 5 collected by the collection unit 21. Specifically, the provision unit 22 transmits the traveling data about the object vehicle 5 identified by the collation unit 23 described below to the insurance company server 3.

However, when there is a change in the steady parking position (described below) of the object vehicle 5 identified by the collation unit 23, the provision unit 22 does not provide the insurance company server 3 with the traveling data of the object vehicle 5. The presence of any change in the steady parking position of the object vehicle 5 can be recognized with reference to a notification from the position acquisition unit 24 described below.

The collation unit 23 collates the object vehicle information 13 for each object vehicle 5 with the designation information included in the provision request received from the insurance company server 3, respectively, and identifies the object vehicle 5 whose traveling data should be provided to the insurance company server 3. Specifically, the collation unit 23 collates the object vehicle registration number being vehicle registration number of the object vehicle 5, included in the object vehicle information 13, with the designated vehicle registration number being vehicle registration number of the vehicle designated by the designation information, included in the designation information. Then, the collation unit 23 identifies an object vehicle 5 whose object vehicle registration number coincides with the designated vehicle registration number, as the object vehicle 5 whose traveling data should be provided to the insurance company server 3.

As described above, the vehicle registration number is the unique code string for identifying each vehicle and also associating the vehicle with an owner of the vehicle. When there is a change in vehicle's owner, a new code string different from the previous one is allocated to the vehicle registration number of this vehicle.

As a result, even in the case of an occurrence of a period in which the owner information differs between the information provision device 1 and the insurance company server 3, with respect to the same object vehicle, because the object vehicle information 13 in the information provision device 1 and the contract information 33 in the insurance company server 3 are individually changed, at mutually different times, it is possible to identify the object vehicle 5 designated by the provision request from the insurance company server 3, without error, from the viewpoint of the same owner, and appropriately transmit the traveling data of the designated object vehicle 5 to the insurance company server 3.

As described above, in the present embodiment, the vehicle registration number may be a code string displayed on the number plate of the vehicle in compliance with regulations. As a result, without defining new identification information or the like for identifying the relationship between the owner and the object vehicle 5, in relation with the insurance company server 3, it is possible to identify the object vehicle 5 designated by the insurance company server 3, without error, from the viewpoint of the same owner, and appropriately transmit the traveling data of the designated object vehicle 5 to the insurance company server 3.

Moreover, in addition to the collation between the designated vehicle registration number and the object vehicle registration number, for example, from the viewpoint of monitoring the consistency between the contract information and the object vehicle information 13, the collation unit 23 may collate information other than the designated vehicle registration number, included in the designation information, with information other than the object vehicle registration number, included in the object vehicle information 13, and notify an operator of the information provision device 1 of collation results.

However, the information other than the designated vehicle registration number included in the designation information may not coincide with the information other than the object vehicle registration number included in the object vehicle information 13. Even in such a case, as long as the designated vehicle registration number coincides with the object vehicle registration number, the collation unit 23 identifies the object vehicle 5 whose object vehicle registration number coincides with the designated vehicle registration number, as the object vehicle 5 whose traveling data should be provided to the insurance company server 3.

The position acquisition unit 24 acquires position information being information on the present position of the object vehicle 5, for example, at predetermined time intervals. The position acquisition unit 24 identifies, from among positions where the object vehicle 5 has been parked, a position where the vehicle has been repeatedly and steadily parked for a predetermined number of days (for example, one month), as a steady parking position of the object vehicle 5. For example, the position acquisition unit 24 can identify a parking position with the highest parking frequency per day, or a parking position with the longest average value in total parking duration per day over a predetermined number of days, as the steady parking position of the object vehicle 5.

Alternatively, the criterion may include time zone. For example, a place where the parking frequency is equal to or greater than a predetermined number of times during night (for example, from 11 PM to 5 AM the next day), or at the timing when the date changes (midnight), may be identified as the steady parking position. Further, under the condition of a specific time zone similar to the above, a parking position with the longest total parking duration may be identified as the steady parking position. In this case, it is possible to exclude the situation where the vehicle is used for commuting or the like and is parked in a parking lot of a workplace during the daytime, and therefore it is possible to identify the steady parking position in private life with high accuracy. In addition, it may be useful to count the number of times for places where the vehicle has been stopped (places where the ignition switch or start switch has been turned off), and identify a place where the number of counts is equal to or greater than a predetermined number of times, as the steady parking position.

Further, when there is a change in the steady parking position, the position acquisition unit 24 notifies the provision unit 22 of the change.

As described above, when there is a change in the steady parking position of the object vehicle 5 identified by the collation unit 23, the provision unit 22 does not provide the insurance company server 3 with the traveling data of the object vehicle 5, based on the notification from the position acquisition unit 24. As a result, the information provision device 1 can quickly determine the possibility that the owner of the object vehicle 5 has been changed, from the tendency in parking position of the object vehicle 5, and can prevent traveling data of the object vehicle 5 whose owner has been changed from being erroneously transmitted, as traveling data of the object vehicle 5 of the original owner, to the insurance company server 3.

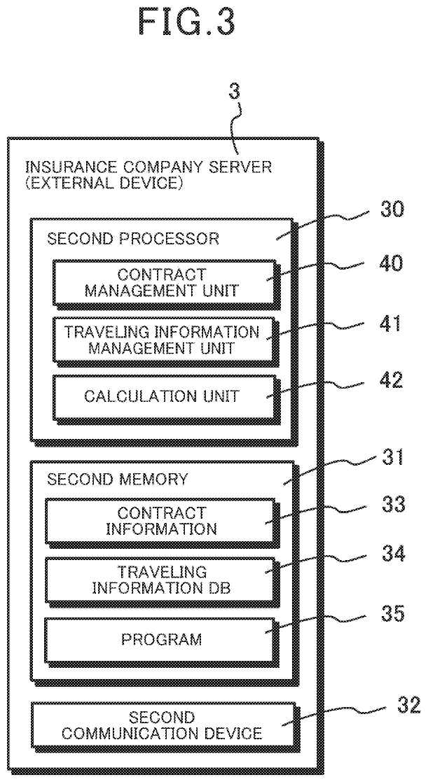

FIG. 3 is a diagram illustrating an exemplary configuration of the insurance company server 3, which is an external device. The insurance company server 3 includes a second processor 30, a second memory 31, and a second communication device 32. The second communication device 32 is a transmitter/receiver that enables the insurance company server 3 to communicate with the information provision device 1 via the communication network 4. The second memory 31 is configured by a volatile and/or nonvolatile semiconductor memory and/or a hard disk device, for example.

The second memory 31 stores the contract information 33 for each insurance contract about each object vehicle 5 being an insurance object. The contract information may include identification information of the object vehicle 5, owner information, and contractor name/address, identification information at the insurance company M, and identification information at the vehicle vendor V. As described above, in the present embodiment, the identification information of the object vehicle 5 is the vehicle registration number (described above) of this vehicle, and specifically, a code string displayed on the number plate of this vehicle in compliance with regulations.

The second processor 30 is, for example, a computer including a processor such as a CPU. The configuration of the second processor 30 may include a ROM for programs installed and a RAM for temporary storage of various data. In addition, the second processor 30 includes, as functional elements or functional units, a contract management unit 40, a traveling information management unit 41, and a calculation unit 42.

These functional elements provided in the second processor 30 can be realized, for example, when the second processor 30 being the computer executes a program 35 stored in the second memory 31. The program 35 may be stored in an arbitrary computer-readable storage medium. Alternatively, the whole or part of the above-described functional elements in the second processor 30 can be configured by hardware including one or more electronic circuit components, respectively.

The contract management unit 40 manages the contract information 33 stored in the second memory 31. For example, in response to reception of an instruction for correcting the contract information 33 of a certain insurance contract from the terminal device 7a or 7b of the user U1 or U2 each being a contractor of this insurance contract, the contract management unit 40 corrects the contents of the instructed contract information 33 according to the contents of the correction instruction.

The traveling information management unit 41 acquires, from the information provision device 1, the traveling data of the object vehicle 5 being an insurance object in the contract information 33. Specifically, based on each contract information 33, the traveling information management unit 41 generates designation information for designating the object vehicle 5 that is required to provide traveling data. As described above, the designation information may include the designated vehicle registration number, which is the vehicle registration number of the above-designated object vehicle 5. In addition, the designation information may include information other than the designated vehicle registration number. The other information may include the whole or part of information (e.g., the above-described owner information and contractor name/address) included in the corresponding contract information 33.

The traveling information management unit 41 transmits, to the information provision device 1, a traveling data provision request including the generated designation information. The traveling information management unit 41 saves traveling data transmitted by the information provision device 1 in response to the provision request in a traveling information DB 34 stored in the second memory 31, while associating it with the contract information 33 about the object vehicle 5 being the acquisition source of the traveling data.

The calculation unit 42 calculates an insurance premium for the insurance contract on the object vehicle 5, based on the traveling data of the object vehicle 5 received from the information provision device 1, saved in the traveling information DB 34. As a result, for example, based on the presence or absence of any dangerous driving or the like that may occur in the object vehicle 5, which can be grasped from the traveling data of the object vehicle 5, it is possible to set the insurance premium for the insurance contract on the object vehicle 5 to an amount of money reflecting the degree of accident occurrence possibility.

For example, based on the traveling data of the object vehicle 5 received from the information provision device 1, the calculation unit 42 calculates the discount amount or discount rate for the insurance premium of the object vehicle 5. Then, based on the discount amount or discount rate, the calculation unit 42 calculates an insurance premium for the insurance contract on the object vehicle 5. As a result, for example, based on the enforcement situation of safe driving in the object vehicle 5, which can be grasped from the traveling data of the object vehicle 5, it is possible to set a lower insurance premium for the object vehicle 5 that is being driven more safely.

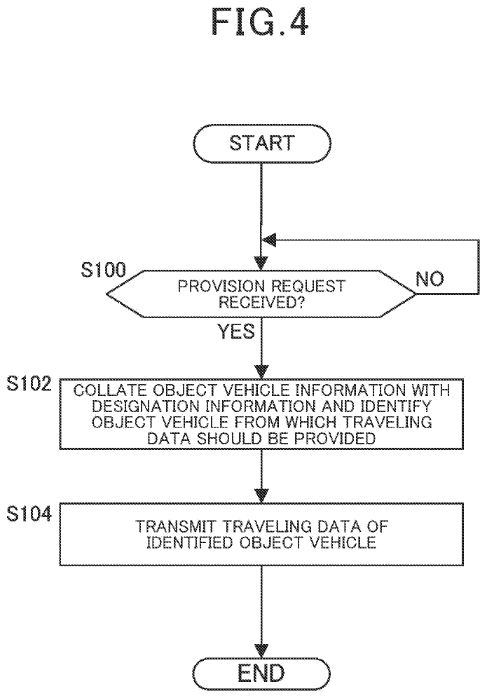

Next, the procedure of operations in the information provision device 1 will be described. FIG. 4 is a flow diagram illustrating an exemplary procedure of processing in an information provision method that the first processor 10 being the computer of the information provision device 1 executes. This processing is repetitively executed. In parallel with this processing, the information provision device 1 causes the collection unit 21 to execute a collection step of collecting traveling data from respective object vehicles 5, for example, at predetermined time intervals. The information provision device 1 may store the collected traveling data in the first memory 11, while associating it with the object vehicle 5 being the collection source, for example. Further, in parallel with this processing, the information provision device 1 causes the position acquisition unit 24 to execute a step of acquiring the position information of the object vehicle 5 from each of the object vehicles 5, at predetermined time intervals, and identifying the steady parking position of the object vehicle 5.

Upon starting the processing, first, the collation unit 23 of the information provision device 1 determines whether the traveling data provision request has been received from an external device that is, for example, the insurance company server 3 (step S100). Then, when no provision request has been received (NO in step S100), the collation unit 23 repeats the processing of step S100 and waits for reception of the provision request.

On the other hand, when the provision request has been received (YES in step S100), the collation unit 23 collates the object vehicle information 13 for each object vehicle 5 with the designation information included in the above-received provision request, and identifies the object vehicle 5 whose traveling data should be provided to the external device (step S102). The step S102 corresponds to a collation step in the present disclosure.

In the present embodiment, especially, in step S102, the collation unit 23 collates the object vehicle registration number being vehicle registration number of the object vehicle 5, included in the object vehicle information 13, with the designated vehicle registration number being vehicle registration number of the vehicle designated by the designation information, included in the designation information, as described above. Then, the collation unit 23 identifies the object vehicle 5 whose object vehicle registration number coincides with the designated vehicle registration number, as the object vehicle 5 from which the traveling data should be provided to the external device.

Next, in response to the above-described provision request received from the external device, the provision unit 22 transmits and provides the traveling data of the object vehicle 5 identified by the collation unit 23 to the external device (step S104), and terminates this processing. The step S104 corresponds to provision step in the present disclosure.

### Other Embodiments

The collation unit 23, when identifying the object vehicle 5 whose traveling data should be provided, may further collate the object vehicle identification number being vehicle identification number (VIN) of the object vehicle 5, included in the object vehicle information 13, with the designated vehicle identification number being vehicle identification number of the vehicle designated by the designation information, included in designation information. The collation unit 23 may identify, as the object vehicle 5 whose traveling data should be provided to the insurance company server 3, the object vehicle 5 whose object vehicle registration number coincides with the designated vehicle registration number and whose object vehicle identification number coincides with the designated vehicle identification number. The vehicle identification number of the object vehicle 5 can be included in the object vehicle information 13 and the contract information 33 as the identification information of the object vehicle 5.

In general, the vehicle identification number information is held by both the vehicle vendor V and the insurance company M. Therefore, identifying the object vehicle 5 using the vehicle registration number and the vehicle identification number as described above makes it possible to identify the object vehicle 5 designated by the designation information, with further lesser error, and appropriately provide the insurance company server 3 with the designated traveling data of the object vehicle 5. Vehicle vendors may manage vehicles whose vehicle registration numbers are not allocated yet, for example, because of undetermined owners. In this case, the vehicle vendors perform management using the vehicle identification number as the standard, search for each vehicle using the vehicle identification number, and correct information about the vehicle. Therefore, when the information provision device 1 handles the object vehicle information 13 including the vehicle identification number, as described above, the information provision device 1 can exhibit excellent identification capability when identifying the object vehicle 5. Further, as described above, since the vehicle identification number is information normally held by the vehicle vendor V, creating the object vehicle information 13 does not require labor and time for acquiring and inputting newly added information.

The present invention is not limited to the configurations of the embodiments described above, and can be implemented in various forms without departing from the gist of the present invention.

For example, the information provision device 1 may transmit traveling data not only to the insurance company server 3 for insurance premium calculation at the insurance company but also to a terminal device (not illustrated) of a vehicle dealer or a vehicle maintenance company. For example, based on the above-described transmitted traveling data, the vehicle dealer can determine the timing for guiding the user U1 or the like about repair parts for the object vehicle 5. Further, based on the traveling data, the vehicle maintenance company can determine the timing for repairment or replacement of each part in the object vehicle 5 or can estimate a faulty part.

Configurations Supported by the Embodiments Described Above

The above-described embodiments support the following configurations.

Configuration 1

An information provision device including a collection unit configured to collect traveling data of a plurality of object vehicles; a provision unit configured to provide, in response to a provision request from an external device, traveling data to the external device; and a collation unit configured to collate object vehicle information for each object vehicle, including information about the object vehicle, with designation information included in the provision request, respectively, and identify an object vehicle from which the traveling data should be provided to the external device. The collation unit collates an object vehicle registration number being a vehicle registration number of the object vehicle, included in the object vehicle information, with a designated vehicle registration number being a vehicle registration number of a vehicle designated by the designation information, included in the designation information, and identifies an object vehicle whose object vehicle registration number coincides with the designated vehicle registration number, as the object vehicle from which the traveling data should be provided to the external device. The vehicle registration number is a unique code string for identifying each vehicle while associating the vehicle with an owner of the vehicle. The provision unit transmits, to the external device, the traveling data about the object vehicle identified by the collation unit.

According to the information provision device of the configuration 1, even in the case of an occurrence of a period in which the owner information differs between the information provision device and the external device, with respect to the same object vehicle, because the object vehicle information in the information provision device and the information about the object vehicle in the external device are individually changed, at mutually different times, it is possible to identify the object vehicle designated by the external device, without error, from the viewpoint of the same owner, and appropriately transmit the traveling data of the designated object vehicle to the external device.

Configuration 2

The information provision device according to the configuration 1, in which the vehicle registration number is a code string displayed on a number plate of the vehicle in compliance with regulations.

According to the information provision device of the configuration 2, it is possible to identify the object vehicle designated by the external device, without error, from the viewpoint of the same owner, and appropriately transmit the traveling data of the designated object vehicle to the external device, without defining new identification information for identifying the relationship between the owner and the vehicle, in relation with the external device.

Configuration 3

The information provision device according to the configuration 2, in which the collation unit further collates an object vehicle identification number being a vehicle identification number of the object vehicle, included in the object vehicle information, with a designated vehicle identification number being a vehicle identification number of a vehicle designated by the designation information, included in the designation information, and identifies the object vehicle whose object vehicle registration number coincides with the designated vehicle registration number and whose object vehicle identification number coincides with the designated vehicle identification number, as the object vehicle from which the traveling data should be provided to the external device.

According to the information provision device of the configuration 3, it is possible to identify the object vehicle designated by the designation information, with further lesser error, and appropriately transmit the traveling data of the designated object vehicle to the external device.

Configuration 4

The information provision device according to the configuration 3, in which the collation unit identifies, as the object vehicle from which the traveling data should be provided to the external device, an object vehicle as long as the object vehicle registration number coincides with the designated vehicle registration number and the object vehicle identification number coincides with the designated vehicle identification number, even when information other than the designated vehicle registration number and the designated vehicle identification number, included in the designation information, does not coincide with information other than the object vehicle registration number and the object vehicle identification number, included in the object vehicle information.

According to the information provision device of the configuration 4, even when various kinds of information including the owner information about the same object vehicle are different between the information provision device and the external device, it is possible to identify the object vehicle designated by the external device, without error, from the viewpoint of the same owner, and appropriately transmit the traveling data of the designated object vehicle to the external device.

Configuration 5

The information provision device according to any one of the configurations 1 to 4, including a position acquisition unit configured to acquire position information being information on the present position of the object vehicle, in which the position acquisition unit identifies, from among positions where the object vehicle has been parked, a position where the number of times of parking or total parking duration, per predetermined number of days, is equal to or greater than a predetermined number of times or equal to or greater than a predetermined amount of time, respectively, as a steady parking position of the object vehicle, and the provision unit does not transmit, when there is a change in the steady parking position of the object vehicle, the traveling data from the object vehicle to the external device.

According to the information provision device of the configuration 5, it is possible to quickly determine the possibility that the owner of the object vehicle has changed, from the tendency in parking position of the object vehicle, and prevent traveling data of the object vehicle whose owner has changed from being erroneously transmitted, as traveling data of the object vehicle of the original owner, to the external device.

Configuration 6

An information provision method that a computer of an information provision device executes, including: a collection step of collecting traveling data of a plurality of object vehicles; a provision step of providing, in response to a provision request from an external device, traveling data to the external device; and a collation step of collating object vehicle information for each object vehicle, including information about the object vehicle, with designation information included in the provision request, respectively, and identifying an object vehicle from which the traveling data should be provided to the external device. The collation step includes collating an object vehicle registration number being a vehicle registration number of the object vehicle, included in the object vehicle information, with a designated vehicle registration number being a vehicle registration number of a vehicle designated by the designation information, included in the designation information, and identifying an object vehicle whose object vehicle registration number coincides with the designated vehicle registration number, as the object vehicle from which the traveling data should be provided to the external device. The vehicle registration number is a unique code string for identifying each vehicle while associating the vehicle with an owner of the vehicle. The provision step includes transmitting, to the external device, the traveling data about the object vehicle identified in the collation step.

According to the information provision method of the configuration 6, even in the case of an occurrence of a period in which the owner information differs between the information provision device and the external device, with respect to the same object vehicle, because the object vehicle information in the information provision device and the information about the object vehicle in the external device are individually changed, at mutually different times, it is possible to identify the object vehicle designated by the external device, without error, from the viewpoint of the same owner, and appropriately transmit the traveling data of the designated object vehicle to the external device.

### REFERENCE SIGNS LIST

1: information provision device
2: insurance information system
3: insurance company server (external device)
4: communication network
5: object vehicle
6: on-vehicle device
7a, 7b: terminal device
10: first processor
11: first memory
12: first communication device
13: object vehicle information
14: information provision program
20: information management unit
21: collection unit
22: provision unit
23: collation unit
24: position acquisition unit
30: second processor
31: second memory
32: second communication device
33: contract information
34: traveling information DB
35: program
40: contract management unit
41: traveling information management unit
42: calculation unit
M: insurance company
U1, U2: user
V: vehicle vendor

What is claimed is:

1. An information provision device, comprising a processor, wherein the processor includes:
a collection unit configured to collect traveling data of a plurality of object vehicles;
a provision unit configured to provide, in response to a provision request from an external device, traveling data to the external device; and
a collation unit configured to collate object vehicle information for each object vehicle, including information about the object vehicle, with designation information included in the provision request, respectively, and identify an object vehicle from which the traveling data should be provided to the external device,
wherein
the collation unit collates an object vehicle registration number being a vehicle registration number of the object vehicle, included in the object vehicle information, with a designated vehicle registration number being a vehicle registration number of a vehicle designated by the designation information, included in the designation information, and
identifies an object vehicle whose object vehicle registration number coincides with the designated vehicle registration number, as the object vehicle from which the traveling data should be provided to the external device,
the vehicle registration number is a unique code string for identifying each vehicle while associating the vehicle with an owner of the vehicle, and
the provision unit transmits, to the external device, the traveling data about the object vehicle identified by the collation unit.

2. The information provision device according to claim 1, wherein the vehicle registration number is a code string displayed on a number plate of the vehicle in compliance with regulations.

3. The information provision device according to claim 2, wherein
the collation unit further collates an object vehicle identification number being a vehicle identification number of the object vehicle, included in the object vehicle information, with a designated vehicle identification number being a vehicle identification number of the vehicle designated by the designation information, included in the designation information, and identifies the object vehicle whose object vehicle registration number coincides with the designated vehicle registration number and whose object vehicle identification number coincides with the designated vehicle identification number, as the object vehicle from which the traveling data should be provided to the external device.

4. The information provision device according to claim 3, wherein
the collation unit identifies, as the object vehicle from which the traveling data should be provided to the external device, an object vehicle as long as the object vehicle registration number coincides with the designated vehicle registration number and the object vehicle identification number coincides with the designated vehicle identification number, even when information other than the object vehicle registration number and the object vehicle identification number, included in the object vehicle information of the object vehicle, does not coincide with information other than the designated vehicle registration number and the designated vehicle identification number, included in the designation information.

5. The information provision device according to claim 1, wherein the processor further comprises:
a position acquisition unit configured to acquire position information being information on the present position of the object vehicle,
in which the position acquisition unit identifies, from among positions where the object vehicle has been parked, a position where the number of times of parking or total parking duration, per predetermined number of days, is equal to or greater than a predetermined number of times or equal to or greater than a predetermined amount of time, respectively, as a steady parking position of the object vehicle, and
the provision unit does not transmit, when there is a change in the steady parking position of the object vehicle, the traveling data from the object vehicle to the external device.

6. An information provision method that a computer of an information provision device executes, the method comprising:
a collection step of collecting traveling data of a plurality of object vehicles;
a provision step of providing, in response to a provision request from an external device, traveling data to the external device; and
a collation step of collating object vehicle information for each object vehicle, including information about the object vehicle, with designation information included in the provision request, respectively, and identifying an object vehicle from which the traveling data should be provided to the external device,
wherein
the collation step includes collating an object vehicle registration number being a vehicle registration number of the object vehicle, included in the object vehicle information, with a designated vehicle registration number being a vehicle registration number of a vehicle designated by the designation information, included in the designation information, and identifying an object vehicle whose object vehicle registration number coincides with the designated vehicle registration number, as the object vehicle from which the traveling data should be provided to the external device,
the vehicle registration number is a unique code string for identifying each vehicle while associating the vehicle with an owner of the vehicle, and
the provision step includes transmitting, to the external device, the traveling data about the object vehicle identified in the collation step.
